(19) United States
(12) Patent Application Publication
(10) Pub. No.: US 2026/0337794 A1
(43) Pub. Date: Oct. 29, 2026

(54) THREE-CHAMBER CELL

(71) Applicant: GIG Karasek GmbH, Gloggnitz (AT)

(72) Inventors: Wolfgang SCHOEFBERGER, Linz (AT); He SUN, Linz (AT)

(73) Assignee: GIG Karasek GmbH, Gloggnitz (AT)

(21) Appl. No.: 19/124,071

(22) PCT Filed: Oct. 17, 2023
(86) PCT No.: PCT/AT2023/060353

§ 371 Date: Apr. 24, 2025

(30) Foreign Application Priority Data
Oct. 25, 2022 (AT) A60166/2022
Nov. 28, 2022 (AT) A50901/2022

(51) Int. Cl. C25B 9/77; C25B 3/26; C25B 9/15; C25B 9/19; C25B 9/63; C25B 11/032; C25B 13/02

(52) U.S. Cl. CPC C25B 9/77; C25B 3/26; C25B 9/15; C25B 9/19; C25B 9/63; C25B 11/032; C25B 13/02

(57) ABSTRACT

A three-chamber cell enables the formation of a three-chamber cell stack with three-chamber cells connected in series. The three-chamber cell includes a gas diffusion electrode a flow plate a flow frame, at least one electrically conductive seal, an anode, and a membrane, in which wherein the conductive seal is present on both sides of the gas diffusion electrode. The two sides of the seal are in electrically conductive contact with one another and the seal lies against one side of the flow plate. On the opposite side of the flow plate, an abutment point for the anode of a subsequent three-chamber cell is present and wherein the abutment point is in electrically conductive contact with the seal via the flow plate.

The invention relates to a three-chamber cell for the electrocatalytic reduction of gases which is suitable for forming a cell stack.

The design of the cell thus enables the construction of an electrochemical three-chamber cell stack.

The three-chamber cell stack can, in particular, be used as a reactor for electrocatalysis.

A cell stack shall be understood as the successive arrangement of a plurality of cells to form a block. A three-chamber cell stack is therefore a block comprising a plurality of individual three-chamber cells.

According to the prior art, there are both “zero-gap” cells and “zero-gap” cell stacks (only for gaseous products), and also individual electrochemical cells in the “three-compartment” cell design (also referred to as “three-chamber cells”, for liquid and gaseous products).

The invention relates in particular to a three-chamber cell for the electrocatalytic CO2 and N2 reaction/reduction to form liquid and gaseous products.

The design of three-chamber cells known from the prior art is briefly described below.

The key part of the three-chamber cell is a gas diffusion electrode which is located between a catholyte chamber and a gas chamber of the three-chamber cell. The third chamber of the three-chamber cell is the anolyte chamber.

The gas chamber is present at the rear side of the gas diffusion electrode. The gas chamber is thereby typically made of insulating material according to the prior art, and is therefore not electrically conductive. A three-chamber cell according to the prior art additionally comprises seals which are also made of insulating material and are therefore not electrically conductive.

On the other side of the gas diffusion electrode is the first liquid chamber or electrolyte chamber, which is referred to as the catholyte chamber due to the arrangement at the cathode (gas diffusion electrode). Catholyte is a word combination of cathode and electrolyte.

At the anode is the second liquid chamber or electrolyte chamber, which is referred to as the anolyte chamber due to the arrangement at the anode. Anolyte is a word combination of anode and electrolyte.

The anolyte chamber and the catholyte chamber are separated by a membrane.

The gas diffusion electrode comes into contact with the gas on one side and with the liquid electrolyte (catholyte) on the other side, which requires high-quality seal materials that are normally non-conductive.

For this reason, the series connection required for a cell stack between the gas diffusion electrode of a first cell of the stack with the anode of a connecting second cell of the stack is not easily realized.

With the known cell stack, it is typical that each component is present in the form of a flat disc or a flat ring, wherein each component extends to the outer perimeter of the stack. At the outer perimeter of the stack, the components are pressed against one another so that the same force acts on each seal of the stack, in particular also the seal of the gas diffusion electrode.

The basis of the invention is the object of providing a design of a three-chamber cell which enables the formation of a three-chamber cell stack with cells connected in series.

To attain the object, it is proposed that the gas chamber be formed by a conductive structured flow plate which lies against the gas diffusion electrode via a conductive seal.

In particular, a three-chamber cell according to claim 1 is proposed to attain the object.

One embodiment of the invention is a three-chamber cell which enables the formation of a three-chamber cell stack with cells connected in series, wherein the three-chamber cell comprises a gas diffusion electrode, a flow plate, a flow frame, at least one electrically conductive seal, an anode, and a membrane, wherein the conductive seal is present on both sides of the gas diffusion electrode, wherein the two sides of the seal are in electrically conductive contact with one another and wherein the seal lies against the flow plate, wherein on the opposite side of the flow plate, an abutment point for the anode of a subsequent three-chamber cell is present and wherein the abutment point is in electrically conductive contact with the seal via the flow plate.

It is preferred that the flow plate is entirely composed of electrically conductive material.

It is preferred that, on the side of the flow plate which lies facing the gas diffusion electrode, there is a depression in which the gas diffusion electrode with the seals thereof is accommodated and wherein a gas conducting structure is present at the base of the depression.

The gas conducting structure is preferably connected to the flow plate in a fixed manner, in particular monolithically. The gas conducting structure can, for example, be milled out of the material of the flow plate.

On the other side of the flow plate, a liquid conducting structure is present as an anolyte conducting structure. Said structure is preferably connected to the flow plate in a fixed manner, in particular monolithically. The anolyte conducting structure can, for example, be milled out of the material of the flow plate.

It is preferred that, on the side of the flow plate which lies facing the anode, there is a depression in which the anode is accommodated and wherein a liquid conducting structure is present at the base of the depression.

It is preferred that the electrically conductive seal is composed of two seals which run around the gas diffusion electrode, which seals protrude past the gas diffusion electrode in a peripheral direction and are connected to one another in the region outside of the gas diffusion electrode, wherein the outer edge region of the gas diffusion electrode is enclosed between the two seals.

It is preferred that the flow frame lies against the seal opposite from the flow plate, wherein the flow frame comprises a raised region which protrudes into the depression of the flow plate, in which depression the gas diffusion electrode with the seal is present.

It is preferred that the side of the flow plate facing the gas diffusion electrode has at least three planes, wherein the bottommost, first plane is formed by the base of a gas conducting structure; wherein the middle, second plane comprises a contact surface for the gas diffusion electrode and the seals thereof, which contact surface runs around the gas conducting structure; wherein the third, upper plane comprises the outer surface of a protrusion which runs around the contact surface.

It is preferred that the protrusion is surrounded by a depression.

It is preferred that the top surface of webs of the gas conducting structure lies in the middle, second plane.

It is preferred that the flow plate comprises two pass-throughs for gas, wherein at least one horizontal gas conducting channel leads into the gas conducting structure starting from each pass-through.

It is preferred that, on the two pass-throughs for gas, there is respectively one receiving space for an insert, wherein the respective horizontal gas conducting channel leads from the receiving space to the gas conducting structure and wherein the insert comprises a connection from the vertical pass-through to the horizontal gas conducting channel.

It is preferred that two types of inserts can be used, wherein the first type has a closed top, so that the pass-through to the next cell is closed, and the second type comprises at least one opening in the top, so that the pass-through to the next cell is open.

It is preferred that the flow plate and the flow frame comprise pass-throughs for the anolyte, the catholyte, and the gas, which pass-throughs are, in a horizontal view, outside of that region of the flow plate in which the gas diffusion electrode is present.

It is preferred that the membrane is present between two seals, wherein the seals comprise pass-throughs for the anolyte, the catholyte, and the gas, which pass-throughs are, in a horizontal view, outside of that region of the flow plate in which the gas diffusion electrode is present.

The pass-throughs for the anolyte, the catholyte, and the gas are preferably present in the following components of the duplicate unit: flow plate, flow frame, the seals of the membrane. The pass-throughs are present such that they are congruent, so that said pass-throughs form vertical channels through the cell and all cells of a cell stack. The anode and the gas diffusion electrode with the seals thereof, and preferably also the membrane, do not comprise any pass-throughs. The anode and the gas diffusion electrode with the seals thereof, and preferably also the membrane, are, in a horizontal view, located in that planar region which lies between the pass-throughs.

The gas conducting structure respectively comprises one connection to each of the two gas pass-throughs. The anolyte conducting structure comprises one connection to each of the two anolyte pass-throughs. The catholyte conducting structure comprises one connection to each of the two catholyte pass-throughs.

The flow of the respective medium thereby occurs from a first pass-through to a second pass-through via the respective conducting structure.

The connection can occur through channels which are outwardly open at the surface of the flow plate or of the flow frame, or through channels or bores which run such that they are enclosed in the material of the flow plate or of the flow frame.

In one embodiment, the invention relates to a three-chamber cell stack, wherein said stack is assembled from a plurality of three-chamber cells according to the invention.

It is preferred that the flow plate of a first of the two outermost three-chamber cells of the cell stack is replaced by a cathode end plate and the flow plate of the second of the two outermost three-chamber cells of the cell stack is replaced by an anode end plate.

In one embodiment, the invention relates to the use of a three-chamber cell stack according to the invention as a reactor for electrocatalysis.

The structure of the flow plate forms at least one flow path for the gas from an inlet to an outlet on the flow plate. The structure or the flow path serves to distribute gas coming from the inlet in a most uniform possible manner over the area of the gas diffusion electrode.

The flow plate comprises a solid body which separates the gas chamber present on the first side of the flow plate from the anolyte chamber present on the rear side of the flow plate. A structure is preferably also present on the rear side of the flow plate. Said structure forms at least one flow path for the liquid anolyte from an inlet to an outlet on the flow plate. The flow of the anolyte and of the gas respectively occurs parallel to the surface of the gas diffusion electrode.

On the other side of the gas diffusion electrode, there is, as is typical according to the prior art, a liquid chamber in the form of the catholyte chamber, which liquid chamber is formed by a flow frame. The flow frame lies against one of the conductive seals of the gas diffusion electrode from the other side. In contrast to the flow plate, the flow frame is open, that is, comprises openings which extend through the base body of the flow frame. As a result, a catholyte chamber is created which is located between the gas diffusion electrode and the membrane which is present on the other side of the flow frame and separates it from the anode. The flow frame comprises an inlet and an outlet for the catholyte. The flow of the catholyte occurs parallel to the two opposing surfaces of the flow frame. A current flow or ion flow through the catholyte from the anode to the cathode (gas diffusion electrode) is enabled by the openings of the flow frame. The flow frame can be formed from electrically insulating material. The flow frame is preferably composed of plastic, for example polytetrafluoroethylene (PTFE), polyether ether ketone (PEEK), or polymethyl methacrylate (PMMA).

The flow plate comprises electrically conductive material or is formed entirely from conductive material, wherein a current flow between the first planar side of the flow plate and the second planar side of the flow plate is enabled. Since the cathode in the form of the gas diffusion electrode (of a first cell) lies against the first planar side of the flow plate via the conductive seal and the anode (of a second cell) lies against the other planar side of the flow plate, a series connection of the cell stack is achieved. The material of the flow plate can be selected from conductive plastic, metal, or graphite. Concrete, non-limiting examples are metals coated with gold, in particular gold-coated bronze, stainless steel, or titanium. The flow plate can be composed entirely of conductive material, or of a combination of conductive material and non-conductive material. For example, a conductive material which extends through the flow plate between the anode and the conductive seal can be inserted or molded into a non-conductive material, such as plastic.

It is preferred that the seal protrudes past and surrounds the gas diffusion electrode at the outer perimeter. The two opposite surfaces of the gas diffusion electrode are thus connected in an electrically conductive manner via the seal. As a result, a current flow between the flow plate and the side of the gas diffusion electrode facing away from the flow plate is also possible. This is particularly relevant, since gas diffusion electrodes exist which are only composed of conductive material on one of their two opposite surfaces.

The flow frame and the flow plate respectively lie against the membrane from different sides in the cell stack via a non-conductive seal. The anode is located between the membrane and the flow plate, wherein the anode is present in a depression of the flow plate and is surrounded by said flow plate. The anode is preferably in conductive contact with the structure of the flow plate facing the anode.

Whether a conductive contact is possible between the gas diffusion electrode and the structure of the flow plate facing the gas diffusion electrode depends on the properties of the gas diffusion electrode used. However, a current flow is not required at this location, since said current flow is achieved via the conductive seal. A gap can also be present between the structure of the flow plate and the gas diffusion electrode.

The conductive seal is formed from an elastically deformable, conductive material. Conductive elastomers are known according to the prior art. For example, the seal can be made from a mixture of conductive carbon, PTFE powder, and a binder, in particular by hot pressing. Graphite seals can also be used.

Compared to the prior art, the present invention is advantageous in that it enables the construction of novel electrochemical three-chamber cell stacks, for the highly-efficient cathode-side production of liquid and gaseous products during electrocatalytic CO2 reduction.

A single cell with the following design is thus present: conductive structured flow plate conductive seal—gas diffusion electrode—conductive seal—flow frame—membrane—anode.

In the case of two successive cells, the anode of one cell is conductively connected to the gas diffusion electrode of the second cell, namely via the conductive structured flow plate located therebetween and the conductive seal.

The cells are present in bipolar connection, that is, in serial electrical connection, so that the same stack current flows through all cells and the stack voltage is the sum of the cell voltages.

The invention is illustrated with the aid of schematic drawings:

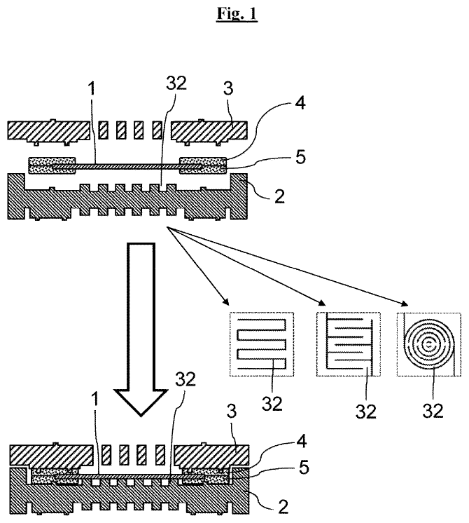

FIG. 1: schematically shows a cathode subunit of a three-chamber cell according to the invention.

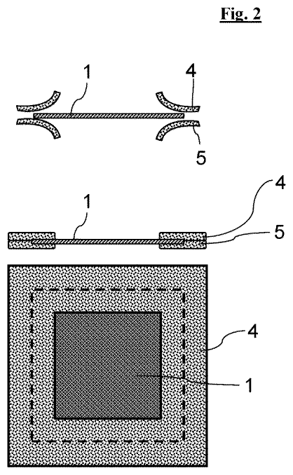

FIG. 2: schematically shows a gas diffusion electrode with seals of a three-chamber cell according to the invention.

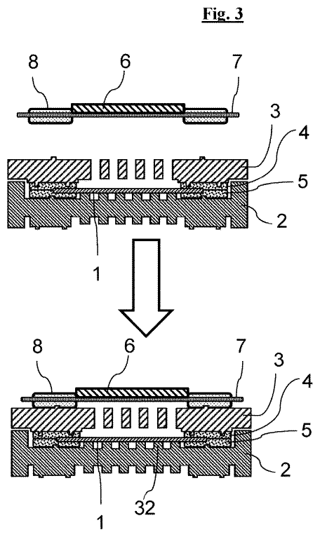

FIG. 3: schematically shows the assembly of an electrode subunit and an anode subunit.

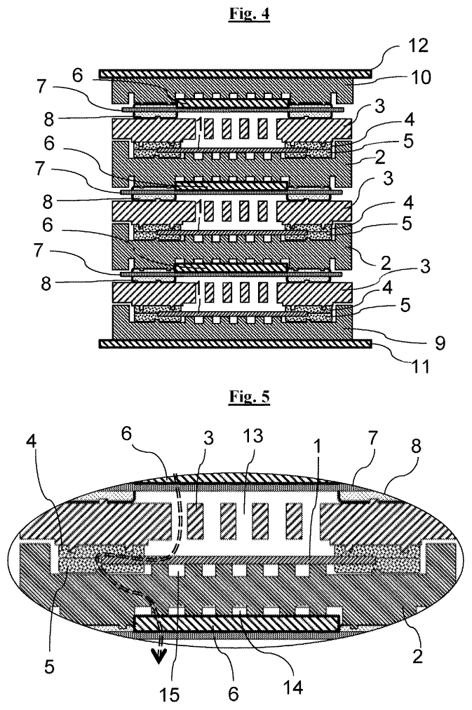

FIG. 4: schematically shows a cell stack made of three-chamber cells according to the invention.

FIG. 5: schematically shows a detailed view of a three-chamber cell according to the invention.

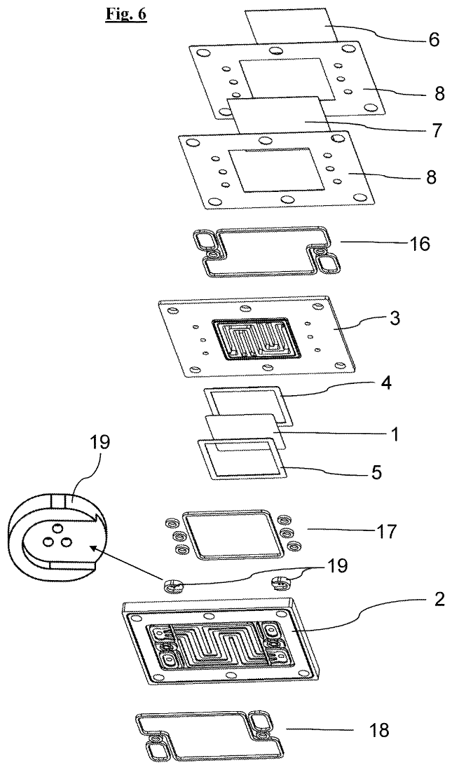

FIG. 6: shows an exploded view of a particularly preferred variant of a three-chamber cell, viewed from a first direction.

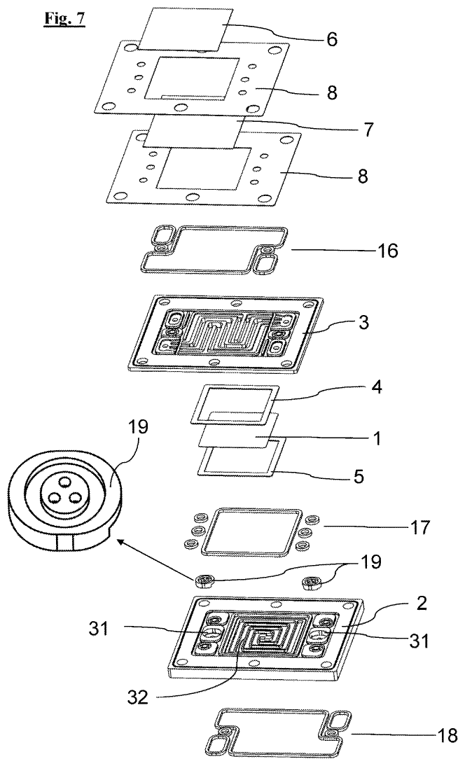

FIG. 7: shows an exploded view of the particularly preferred variant of a three-chamber cell, viewed from the second direction.

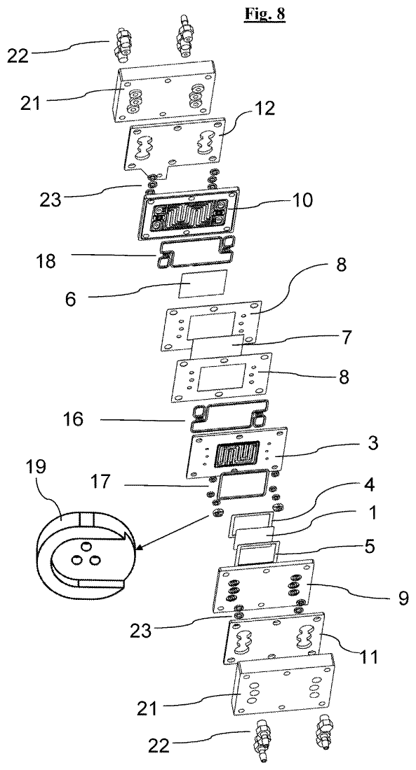

FIG. 8: shows an exploded view of a particularly preferred variant of a three-chamber cell stack, viewed from a first direction.

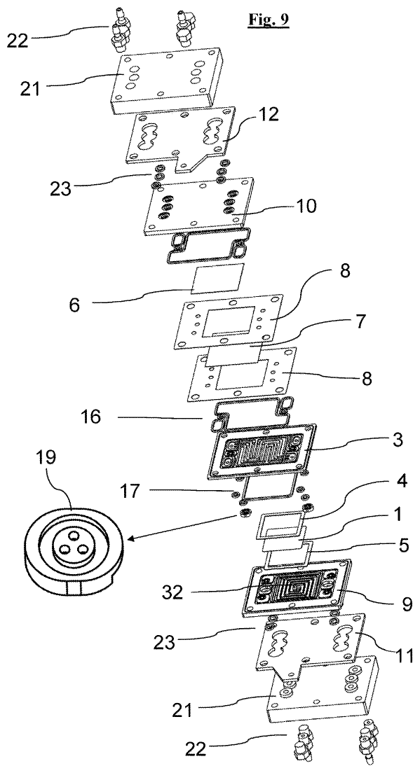

FIG. 9: shows an exploded view of the particularly preferred variant of a three-chamber cell stack, viewed from the second direction.

FIG. 10: shows a particularly preferred variant of a first side of a flow plate.

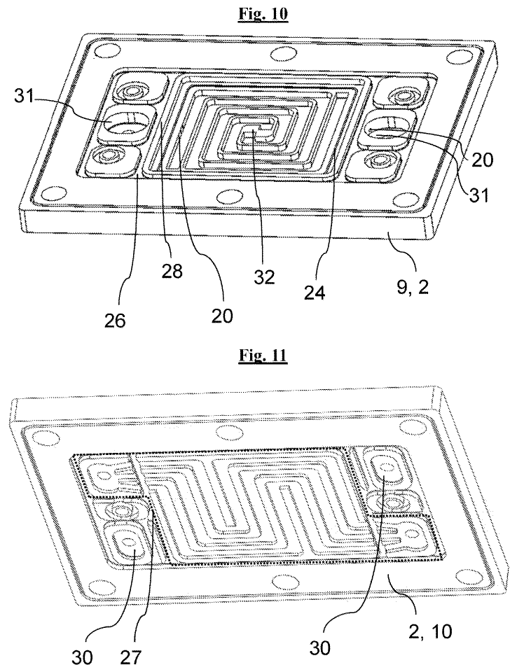

FIG. 11: shows a particularly preferred variant of a second side of a flow plate.

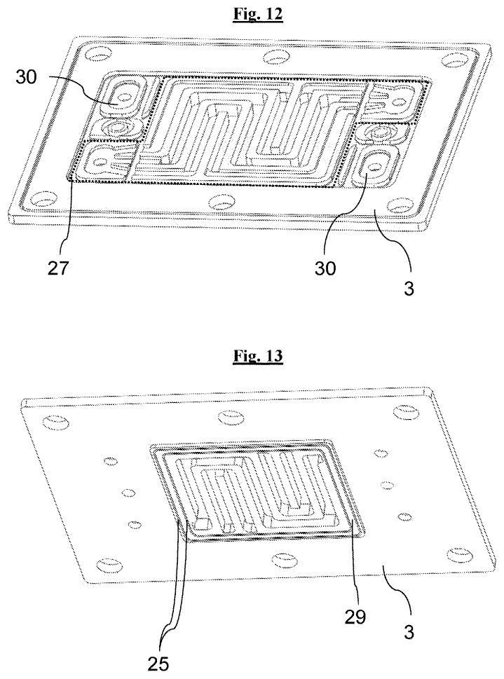

FIG. 12: shows a particularly preferred variant of a first side of a flow frame.

FIG. 13: shows a particularly preferred variant of a second side of a flow frame.

The directional indications perpendicular or vertical herein refer to the direction which is perpendicular to the plane of the gas diffusion electrode 1, which corresponds to the longitudinal direction of the cell stack. Horizontal is used to denote the direction parallel to the plane of the gas diffusion electrode 1.

FIG. 1 schematically illustrates how a gas diffusion electrode 1, a flow plate 2, and a flow frame 3 can be assembled to form a cathode subunit.

The gas diffusion electrode I can be embodied according to the prior art. According to the invention, said electrode is provided with an electrically conductive seal 4, 5. As depicted, the seal can be assembled from a first conductive seal 4 and a second conductive seal 5.

The flow plate 2 comprises a depression in which the gas diffusion electrode 1 with the seals thereof 4, 5 is accommodated, wherein the second conductive seal 5 lies against the base of the depression. The base of the depression can comprise at least one raised web which is pressed into the seal 5 when the components are pressed together. The web can be located in a region in which the gas diffusion electrode 1 is located between the seals 4, 5.

The gas diffusion electrode 1 is exposed in the region between the peripheral seals 4, 5. In said region, a raised structure which serves as a gas conducting structure 32 is arranged on the base of the depression of the flow plate 2.

On the other side of the gas diffusion electrode 1, the flow frame 3 is present opposite the flow plate 2. Said flow frame 3 preferably comprises a peripheral frame, the frame legs of which are connected by material bridges. Between the material bridges, the flow frame 3 comprises openings which extend from one area of the flow frame 3 to the opposite area thereof.

Preferably, the flow frame 3 comprises a raised element which corresponds to the depression of the flow plate 2. In the pressed-together state, the raised element of the flow frame 3 preferably protrudes into the depression of the flow plate 2. The raised element lies against the first seal 4. The surface of the raised element can comprise at least one raised web which is pressed into the seal 4 when the components are pressed together. In the example from FIG. 1, two parallel webs are present on the raised element. The inner web can be located in a region in which the gas diffusion electrode 1 is located between the seals 4, 5. The outer web can be located in a region in which the seals 4, 5 lie directly against one another.

FIG. 1 illustrates by way of example structures which can be present on the flow plate 2 as a gas conducting structure 32 and/or as a liquid conducting structure.

In FIG. 2, a possible production method for the gas diffusion electrode 1 with the seals 4, 5 thereof is illustrated. The seals 4, 5 are thereby respectively present as frame-shaped flat material. The respective frame is embodied such that the outer edge thereof lies outside of the perimeter of the gas diffusion electrode 1 and such that the inner edge thereof lies inside of the perimeter of the gas diffusion electrode 1. In the example from FIG. 2, the gas diffusion electrode 1 and the seals 4, 5 are embodied to be square, as can be seen in the top view. However, other shapes are not excluded; for example, the gas diffusion electrode I could be rectangular, round, oval, or polygonal.

The outer shape of the flow plate 2 and of the flow frame 3 can correspond to the shape of the gas diffusion electrode 1 or can be different. For example, a round gas diffusion electrode 1 could be inserted into a round depression of an angular flow plate 2.

FIG. 3 illustrates how the previously assembled cathode subunit is assembled with an anode subunit to form a duplicate unit for the formation of cell stacks.

The anode subunit comprises the anode 6 which is present on a membrane 7. The anode 6 can be connected to the membrane 7 in a fixed manner, for example compressed. The membrane 7 protrudes past the anode 6 and comprises a seal 8 in the region protruding past the anode 6. As depicted, one seal 8 each can be present on the two opposite sides of the membrane 7. The membrane 7 can laterally protrude out of the seal 8 or between the seals 8. The seal 8 is formed from electrically insulating material. Less preferably, the membrane 7 can be present directly between the flow plate 2 and the flow frame 3 if the material thereof permits a seal or if a seal is directly present between the flow plate 2 and the flow frame 3 in the region outside of the membrane 7.

In the example from FIG. 3, the anode subunit is positioned on the exposed side of the flow frame 3. However, it would also be conceivable to position the anode subunit on the exposed side of the flow plate 2, since it is ultimately only crucial for the duplicate unit of the stack that said duplicate unit comprises all components for the formation of a three-chamber cell.

The side of the flow frame 3 facing the membrane 7 is preferably embodied to be flat (without protrusion or depression). In the region of the seal 8, there is preferably at least raised web which is pressed into the seal 8 when the components are pressed together.

A finished duplicate unit comprises the following components: anode 6; membrane 7; seal(s) 8; flow frame 3; seal(s) 4, 5; gas diffusion electrode 1; flow plate 2.

In order for a duplicate unit to become a three-chamber cell, it is necessary to close said duplicate unit on the bottom side in that a further duplicate unit is positioned there, or the flow plate 2 is replaced by a cathode end plate 9.

The closing of the bottom side of the flow plate 2 occurs by means of the membrane 7. Preferably, the flow plate 2 comprises on the side facing the membrane 7 an inner depression, on the base of which a raised structure is present which serves as a liquid conducting structure of the anolyte. The anode 6 lies against this structure. When the components are pressed together, the anode 6 is located in the inner depression of the flow plate 2. Externally around the inner depression, there follows a region that is raised relative to the inner depression, which region lies against the seal 8. The surface of the raised region can comprise at least one raised web which is pressed into the seal 8 when the components are pressed together. In the example from FIG. 3, two parallel webs are present at the raised region.

It is generally preferred that one web is present on one side of the respective seal 4, 5 and seal 8 and two webs are present on the other side of the respective seal 4, 5 and seal 8.

Around the raised region which surrounds the inner depression, a peripheral depression can be present, wherein a second raised region is externally present around the peripheral depression. The second raised region can protrude from the flow plate farther than the previously described raised region against which the seal 8 lies. The second raised region can be present such that it is symmetrical with that protrusion which, on the other side of the flow plate 2, surrounds that depression in which the gas diffusion electrode 1 is inserted.

FIG. 4 illustrates an exemplary cell stack. Said cell stack can be assembled from any desired number of duplicate units or three-chamber cells.

As depicted, one end of the stack is bounded by a cathode end plate 9 and the other end of the stack by an anode end plate 10. On one side, the cathode end plate 9 is embodied such that it corresponds to that side of the flow plate 2 on which the gas diffusion electrode 1 is present. The other side is embodied to be planar or flat, for example. On one side, the anode end plate 10 is embodied such that it corresponds to that side of the flow plate 2 on which the anode 6 is present. The other side is embodied to be planar or flat, for example.

A cathode current collector 11 can be present on the cathode end plate 9.

An anode current collector 12 can be present on the anode end plate 10.

By applying a voltage between the end plates 9, 10 or the current collectors 11, 12 thereof, a current flow occurs through the cell stack.

FIG. 5 shows a detailed view of a three-chamber cell of the cell stack, wherein the current flow is illustrated by an arrow.

As depicted, the three-chamber cell comprises a catholyte chamber 13 which is present between the membrane 7 and the gas diffusion electrode 1 and is laterally bounded by the flow frame 3. The catholyte chamber 13 is laterally sealed by the seal 8 and the seal 4.

The three-chamber cell comprises an anolyte chamber 14 which is present between the anode 6 and the flow plate 2, wherein the flow plate 2 also forms the lateral boundary of the anolyte chamber 14. The anolyte chamber 14 is laterally sealed by the seal 8.

The three-chamber cell comprises a gas chamber 15 which is present between the gas diffusion electrode 1 and the flow plate 2, wherein the flow plate 2 also forms the lateral boundary of the gas chamber 15. The gas chamber 15 is laterally sealed by the seal 5.

In FIG. 5, the current flow through the three-chamber cell is illustrated by the arrow. The flow through the membrane 6, that is, the flow between the anolyte and catholyte, thereby occurs by means of ion transport. Preferably, that side of the gas diffusion electrode I which lies facing the catholyte is embodied to be conductive, and the other side is embodied to be insulating or less conductive. The current flow therefore occurs in the conductive layer of the gas diffusion electrode 1 towards the seal 4, and from the seal 4 into the seal 5. The seal 5 conducts the current into the flow plate 2, which is in contact with the anode 6 of the next three-chamber cell. The current flow between the flow plate 2 and anode 6 preferably occurs via the liquid conducting structure of the flow plate 2.

Whereas FIGS. 1-5 illustrate only the core region of the three-chamber cells, the pass-throughs for the gas, the anolyte, and the catholyte, which pass-throughs run vertically through the cell and the stack, are also illustrated in FIGS. 6-13. Also, in FIGS. 6-9, additional seal sets 16, 17, 18 for sealing said pass-throughs are illustrated. The flow plate 2 and the flow frame 3 from FIGS. 6-9 are depicted in an enlarged manner in FIGS. 10-13.

FIGS. 6, 8, and 11 provide a view of the anolyte conducting structure of the flow plate 2. FIGS. 7, 9, and 10 provide a view of the gas conducting structure of the flow plate 2.

FIGS. 6, 8, and 13 provide a view of the side of the flow frame 3 facing the gas diffusion electrode 1. FIGS. 7, 9, and 12 provide a view of the side of the flow frame 3 facing the membrane 7.

In the depicted example from FIGS. 6-9, the flows of the gas and of the two liquids occur in parallel through the stack, since the flow plate 2, the flow frame 3 and the seals 8 respectively comprise two pass-throughs running perpendicularly through the stack for the gas and each of the liquids. One or more flows selected from the flows of the gas and of the two liquids can also take place serially through the stack if one of the pass-throughs running perpendicularly through the stack for the gas and the liquids is closed or not present on one of the named elements.

The selection between parallel flow and serial flow can take place via inserts 19 which are provided with a pass-through in one embodiment and without a pass-through in a second embodiment. It is particularly preferred if, as illustrated, an insert 19 of this type is present for the gas channels. The depicted insert 19 additionally has the function of creating a connection of the pass-through of the flow plate 2 to the gas conducting structure 32 of the flow plate 2. For this purpose, the insert 19 comprises an opening or recess which is oriented in the direction of the gas conducting structure 32. From an inner wall of the receiving space 31 for the insert 19, at least one gas conducting bore 20 (or one other opening which is not produced by drilling) runs up to a wall of the gas conducting structure 32. Thus, with this gas conducting bore 20 in the material of the flow plate 2, a horizontal gas channel is formed between the pass-through and the gas conducting structure 32.

The insert 19 can comprise a depression for a sealing element of the seal set 17. Alternatively, a sealing element of the seal set 17 can be present around the insert 19 in a depression of the flow plate 2.

The depicted inserts 19 all comprise a pass-through. An insert 19 without a pass-through has a closed top (without the three bores, wherein for this type of insert, the depression in the insert for the O-ring is also not required).

The insert 19 is preferred, since it facilitates the production of the flow plate 2. In place of the insert, however, it would also be possible for there to be only one pass-through for the gas on the flow plate 2, from which pass-through a horizontal gas channel runs to the gas conducting structure 32.

The outlet of the horizontal gas channel lies between the base of the gas conducting structure 32 and the gas diffusion electrode 1.

The flow plate 2 comprises a receiving depression for the gas diffusion electrode I with the seals 4, 5 thereof. Said seals 4,5 therefore do not protrude to the outer perimeter of the cell or of the stack. The receiving depression is bounded by a peripheral protrusion 28 of the flow plate 2.

The top surfaces of the webs of the gas conducting structures 32 and the contact surface present around the gas conducting structure 32 for the gas diffusion electrode 1 with the seals 4, 5 thereof form the base of the receiving depression. The top surfaces of the webs and contact surface can thereby lie in a shared second plane. The base of the gas conducting structure 32 lies in a first plane below the second plane. On the contact surface, a single web 24 is present in the illustrated example, for enhancing the sealing effect. The peripheral protrusion 28 of the flow plate 2 is present around the contact surface, wherein the top surface of the protrusion 28 lies in a third plane above the second plane. The protrusion 28 is preferably surrounded by a depression 26, the base of which can lie in the second plane or another plane.

Around the protrusion 28, there preferably runs a sealing element (in particular rectangular sealing ring) of the seal set 17. Additionally, the seal set 17 preferably comprises one sealing element each (in particular O-ring) which is present around the respective feed-through. Preferably, the flow plate 2 comprises a depression for the respective sealing element around the respective pass-through. As depicted, that depression 26 which runs around the protrusion 28 can also run around a projection of the respective pass-through; however, this is optional. In place of the illustrated rectangular sealing element of the seal set 17, a sealing element could also be present which corresponds to the shape of the entire illustrated depression 26, so that the sealing element surrounds the protrusion 28 and each pass-through individually. In this case, it would be possible to omit the individual sealing elements (in particular O-ring) of the seal set 17.

Externally around the noted depression 26, a frame-shaped contact region for the flow frame 3 is present.

At this contact region, multiple passage openings, in particular six passage openings, for fasteners, in particular threaded bolts or screws, are present. Externally around these passage openings, a peripheral groove can be present in the contact region. The surface of the contact region preferably lies in the third plane.

The insert 19 illustrated in FIGS. 6-9 in an enlarged manner can be present such that it is made of sealing material and is larger than the receiving space 31 for the insert, so that said insert 19 can be pressed into the receiving space 31 in a sealing manner. Alternatively, the insert 19 can be adhered into the receiving space 31 using gas-tight adhesive or a curing epoxy. Another possibility is a sealing element which is present around the insert 19 on the flow plate 2, for example in the ring space which forms the depression 26 around the projection on which the receiving space 31 is present.

In the example, the gas conducting structure 32 is embodied as a closed structure, so that the gas flow must occur past the webs of the structure, that is, between the surface of the webs and the gas diffusion electrode 1. Alternatively, the structure can also form one or more continuous connections between the two opposing gas conducting bores 20.

It is preferred that the respective gas pass-through lies between the pass-throughs for the liquids. It is preferred that the pass-throughs are present along two opposite edges of a square or rectangular flow plate 2, preferably on the shorter edge of a rectangular flow plate 2.

In FIG. 13, the side of the flow frame 3 which lies facing the flow plate 2 is depicted. This side comprises a first area which lies against the contact region and the protrusion 28 of the flow plate 2. The sealing elements of the seal set 17 are thereby pressed into the depression provided for the respective sealing element. In the inner region of the first area, a second area is present which is raised relative to the first area and thus forms a raised region 29. The raised region 29 is accommodated in the receiving depression of the flow plate 2 and presses the seals 4, 5 against the contact surface of the flow plate 2. The raised region 29 comprises a frame-shaped outer region which surrounds the catholyte conducting structure of the flow frame 3. In said outer region, there is preferably a peripheral web, in particular a peripheral double web 25, in order to enhance the sealing effect. The catholyte conducting structure is formed by one or more channels, wherein at least one of the channels is embodied as a passage opening through the flow frame 2, or is provided with passage openings. In FIG. 13, those channels are visible which completely extend through the flow frame 2. In FIG. 12, additional channels are visible which comprise a groove base.

The flow frame 3 preferably comprises an identical outer perimeter or an identical size as the flow plate 2. Corresponding to the flow plate 2, the flow frame 3 comprises multiple passage openings, in particular six passage openings, for fasteners, in particular threaded bolts or screws. The fasteners are formed from non-conductive material, or are present in sleeves made of non-conductive material.

The sides of the flow frame 3 (FIG. 12) and of the flow plate 2 (FIG. 11) facing the anode 6 can be embodied to be nearly identical to one another, with the difference that the catholyte conducting structure of the flow frame 3 comprises passage openings and the anolyte conducting structure of the flow plate 2 comprises a closed base. However, the two sides noted can also be embodied to be different from one another.

The catholyte conducting structure of the flow frame 3 comprises on both sides a connection to the symmetrically (not shown, but optionally possible) or diagonally (as shown) opposite pass-throughs for the catholyte.

The anolyte conducting structure of the flow plate 2 comprises on both sides a connection to the symmetrically (not shown, but optionally possible) or diagonally (as shown) opposite pass-throughs for the anolyte.

The illustrated groove, which is present between the respective pass-through and the respective structure such that it is transverse to the (as shown, three of each) horizontal channels, is optional.

The respective conducting structure and the two pass-throughs connected thereto are surrounded by a depression 27 in which the correspondingly shaped sealing element of the seal set 18 or of the seal set 16 is inserted. In order to illustrate the pathway of the depression 27, it is illustrated as a dotted line.

Around the four unneeded pass-throughs, other sealing elements of the seal set 18 or of the seal set 16 are present. Alternatively, an individual sealing element can also comprise three or five of the illustrated sealing elements (for example, in that the respective opening surrounded by a sealing element is punched out or cut out of a planar sealing element).

The provision of separate sealing elements for each liquid and/or for the gas has the advantage that the material of the seal can be adapted to the medium in a targeted manner.

The seals of the seal sets 16 and 18 can be embodied to be identical to one another.

Around the two respectively unneeded pass-throughs for the other liquid, a receiving space 30 for a closure element can be present as shown. If a closure element of this type is positioned in one of the two receiving spaces, a serial flow of the liquid through the cell is achieved.

A peripheral groove can be present externally around the passage openings for fasteners.

The sides of the flow plate 2 and of the flow frame 3 depicted in FIGS. 11 and 12 lie opposite from one another in the assembled stack, wherein the membrane 7 with the seals 8 thereof and the anode 6 are present therebetween. The anode 6, which is typically composed of porous material, lies against the anolyte conducting structure of the flow plate 2. Depending on the thickness of the anode 6, the plane of the top surfaces of the webs of the anolyte conducting structure can be present such that they are recessed relative to the outer frame-shaped area of the flow plate 2.

The seals 8 preferably protrude to the outer perimeter of the cell, wherein the seals 8 respectively comprise passage openings for fasteners and two pass-throughs each for each of the media (anolyte, catholyte, gas).

Finally, FIGS. 8 and 9 also illustrate those components which bound the stack at the two ends. For the sake of clarity, the depicted stack comprises only one three-chamber cell, wherein said cell can be expanded by the addition of a duplicate unit.

At one end of the stack, a cathode end plate 9 is arranged, the side of which that faces the gas diffusion electrode 1 is embodied as depicted in FIG. 10 and described in relation thereto.

At the other end of the stack, an anode end plate 10 is arranged, the side of which that faces the anode 6 is embodied as depicted in FIG. 11 and described in relation thereto.

The respective other side of the cathode end plate 9 and anode end plate 10 can be embodied to be flat, wherein depressions for the end seals 23 can be present around the pass-throughs. Preferably, the end seals 23 are separate O-rings for each of the pass throughs. On the sides of the end plates 9, 10 facing away from the cells, a planar current collector 11, 12 is respectively present which is composed of a conductive material, for example copper or aluminum. The respective current collector 11, 12 preferably comprises a connecting tab which protrudes laterally out of the stack. The current collectors 11, 12 comprise openings for the pass-throughs and the seals thereof.

Externally on the current collectors 11, 12, cover plates 21 are present, preferably made of non-conductive material. The cover plates 21 can comprise protrusions which press on the end seals 23 through the current collectors 11, 12. On the outer side, the cover plates 21 comprise openings for the insertion of connectors and closures 22. The connectors and closures 22 can be pressed, adhered, or screwed into the cover plates 21. Tubing or piping can be connected at the connectors. The closures serve to seal off pass-throughs at the end side. On each side of the stack, three connectors and three closures are positioned, so that the respective medium proceeds from an inlet on a first side of the stack to an outlet on a second side of the stack. The media can flow through the stack in the same direction or in an opposing manner.

The use of cover plates 21 with two pass-throughs each for each medium has the advantage that the connectors and closures 22 can be positioned according to the manner of flow intended in the stack (parallel or serial).

Less preferably, specific cover plates 21 and/or end plates 9, 10 can also be used which respectively comprise only one pass-through for each medium and thus replace the freely positionable closures.

The end plates 9, 10 and current collectors 11, 12 and cover plates 21 comprise passage openings for the fasteners.

The fasteners are not shown. Said fasteners respectively run through the entire stack. The fasteners can comprise a thread on both sides, or can be equipped with a head and thread. The fasteners could also be part of one of the cover plates 21, or could be screwed into one of said cover plates 21, and protrude through the second cover plate at the other end.

This manner of fastening or of pressing-together of the stack is preferred. Other manners are not intended to be excluded, however. For example, it would be possible to omit the passage openings and press the stack together using external tension means. The external tension means can run from one cover plate 21 to the other cover plate 21, namely outside of the outer perimeter of the three-chamber cells, wherein in this case the cover plates 21 must horizontally protrude past the three-chamber cells.

Listing of Claims

1. A three-chamber cell which enables the formation of a three-chamber cell stack with three-chamber cells connected in series, wherein the three-chamber cell comprises a gas diffusion electrode, a flow plate, a flow frame, at least one electrically conductive seal, an anode, and a membrane, wherein the conductive seal is present on both sides of the gas diffusion electrode wherein the two sides of the seal are in electrically conductive contact with one another and wherein the seal lies against one side of the flow plate wherein on the opposite side of the flow plate, an abutment point for the anode of a subsequent three-chamber cell is present and wherein the abutment point is in electrically conductive contact with the seal via the flow plate.

2. The three-chamber cell according to claim 1, wherein the flow plate is entirely composed of electrically conductive material.

3. The three-chamber cell according to claim 1, wherein, on the side of the flow plate which lies facing the gas diffusion electrode, a depression is present in which the gas diffusion electrode with the seals thereof is accommodated and wherein a gas conducting structure is present at the base of the depression.

4. The three-chamber cell according to claim 1, wherein, on the side of the flow plate which lies facing the anode, a depression is present in which the anode is accommodated and wherein a liquid conducting structure is present at the base of the depression.

5. The three-chamber cell according to claim 1, wherein the electrically conductive seal is composed of two seals which run around the gas diffusion electrode, which seals protrude past the gas diffusion electrode in a peripheral direction and are connected to one another in the region outside of the gas diffusion electrode, wherein the outer edge region of the gas diffusion electrode is enclosed between the two seals.

6. The three-chamber cell according to claim 1, wherein the flow frame lies against the seal opposite from the flow plate, wherein the flow frame comprises a raised region which protrudes into the depression of the flow plate, in which depression the gas diffusion electrode with the seal is present.

7. The three-chamber cell according to claim 1, wherein the side of the flow plate facing the gas diffusion electrode has at least three planes, wherein the bottommost, first plane is formed by the base of a gas conducting structure wherein the middle, second plane comprises a contact surface for the gas diffusion electrode and the seals thereof, which contact surface runs around the gas conducting structure; wherein the third, upper plane comprises the outer surface of a protrusion which runs around the contact surface.

8. The three-chamber cell according to claim 7, wherein the protrusion is surrounded by a depression.

9. The three-chamber cell according to claim 7, wherein the upper surface of webs of the gas conducting structure lies in the middle, second plane.

10. The three-chamber cell according to claim 7, wherein the flow plate comprises two pass-throughs for gas, wherein at least one horizontal gas conducting channel leads into the gas conducting structure starting from each pass-through.

11. The three-chamber cell according to claim 10, wherein, on the two pass-throughs for gas, there is respectively one receiving space for an insert wherein the respective horizontal gas conducting channel leads from the receiving space to the gas conducting structure and wherein the insert comprises a connection from the vertical pass-through to the horizontal gas conducting channel.

12. The three-chamber cell according to claim 11, wherein two types of inserts can be used, wherein the first type has a closed top, so that the pass-through to the next cell is closed, and the second type comprises at least one opening in the top, so that the pass-through to the next cell is open.

13. The three-chamber cell according to claim 1, wherein the flow plate and the flow frame comprise pass-throughs for the anolyte, the catholyte, and the gas, which pass-throughs are, in a horizontal view, outside of that region of the flow plate in which the gas diffusion electrode is present.

14. The three-chamber cell according to claim 13, wherein the membrane is present between two seals wherein the seals comprise pass-throughs for the anolyte, the catholyte, and the gas, which pass-throughs are, in a horizontal view, outside of that region of the flow plate in which the gas diffusion electrode is present.

15. A three-chamber cell stack, wherein said three-chamber cell stack is assembled from a plurality of three-chamber cells according to claim 1.

16. The three-chamber cell stack according to claim 15, wherein the flow plate of a first of the two outermost three-chamber cells is replaced by a cathode end plate and the flow plate of the second of the two outermost three-chamber cells is replaced by an anode end plate.

17. A use of a three-chamber cell stack according to claim 15 as a reactor for electrocatalysis.
